(19) United States
(12) Patent Application Publication
(10) Pub. No.: US 2006/0132664 A1
(43) Pub. Date: Jun. 22, 2006

(54) Projection television

(76) Inventor: Jong-chul Choi, Suwon-si (KR)

Correspondence Address: STANZIONE & KIM, LLP, 919 18TH STREET, N.W., SUITE 440, WASHINGTON, DC, 20006, US

(21) Appl. No.: 11/294,400

(22) Filed: Dec. 6, 2005

(30) Foreign Application Priority Data
Dec. 20, 2004 (KR) 2004-108893

(51) Int. Cl. H04N 9/12; H04N 9/31

(52) U.S. Cl. 348/743; 348/744

(57) ABSTRACT

A projection television includes a video processor to process input video signals, a single CRT to project light according to the processed video signals, a color wheel located in a front of the CRT to filter the light projected from the CRT into predetermined colored light, and a controller to control a rotation of the color wheel according to the input video signals. The projection television uses the color wheel to realize colored light by dividing light produced by the single CRT.

### CROSS-REFERENCE TO RELATED APPLICATIONS

This application claims the benefit under 35 U.S.C. §119 from Korean Patent Application No. 2004-108893, filed on Dec. 20, 2004, in the Korean Intellectual Property Office, the disclosure of which is incorporated herein in its entirety by reference.

### BACKGROUND OF THE INVENTION

1. Field of the Invention

The present general inventive concept relates to a projection television, and more particularly, to a color projection television with a single cathode ray tube (CRT).

2. Description of the Related Art

FIG. 1 illustrates a conventional projection television.

As illustrated in FIG. 1, the conventional projection television employs three CRTs. Each CRT projects one of red, green, and blue to realize a color image.

That is, each CRT projects one of the red, the green, and the blue to realize the color image and has one of red, green and blue colored-lenses that are attached to a front part of the corresponding one of the CRTs.

However, as illustrated in FIG. 1, in case of using the three CRTs, it is complicated to control an axis of each CRT, an optical axis and an adjustment of a total conjugate length (TCL). A convergence may occur due to a difference of locations of the CRTs. Therefore, a special step for the adjustment of the convergence may be required.

### SUMMARY OF THE INVENTION

The present general inventive concept provides a projection television that uses a color wheel as to realize colored images by dividing light emitted from a single CRT into colored lights.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing a projection television comprising a video processor to process input video signals, a single CRT to project light according to the processed video signals, a color wheel located in a front of the CRT to filter the light projected from the CRT into predetermined colored-light corresponding to the respective processed video signals, and a controller to control a rotation of the color wheel according to the input video signals.

The video processor may process the input video signals to divide into R, G, and B signals, and to merge or arrange the R, B, and G signals in a sequence, and the CRT projects the light according to the merged R, G, and B signals in the sequence.

The controller may control the color wheel to filter the light into red, green and blue colored-light based on the R, G, and B signals corresponding to the light which is projected from the CRT.

The colored light may comprise red, green and blue colored-light and the color wheel may comprise red, green and blue color filters to generate the red, green and blue colored-light from the projected light.

The CRT may comprise a colorless lens through which the light projected from the CRT is transmitted.

The controller may control the color wheel to rotate according to a predetermined period corresponding to a frequency of the input video signals.

The foregoing and other aspects of the present general inventive concept may also be achieved by providing a projection television including a single CRT to project light according to a video signal, a color wheel having a plurality of filters to receive the light and to generate colored light, a mirror to reflect the colored light and a screen to project the reflected colored light as an image.

The foregoing and other aspects of the present general inventive concept may also be achieved by providing a projection television including a housing, a single CRT disposed in the housing to project a first, a second, and a third light according to a first, a second, and a third video signal, a color wheel disposed in the housing to generate a first, a second and a third colored light according to the projected first, second and third light, respectively, a mirror to sequentially reflect the first, second and third colored-light, and a screen to display an image according to the reflected first, second and third colored light.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional projection television.

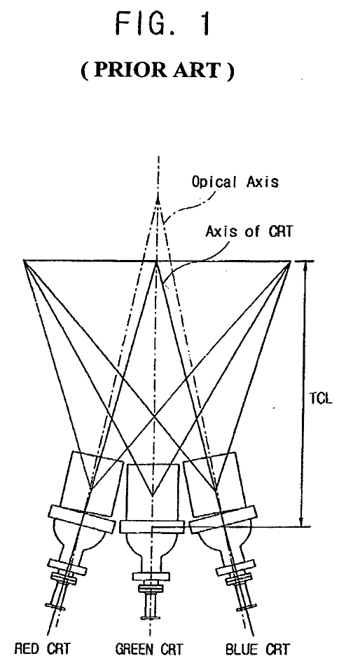

FIG. 2 is a control block diagram of a projection television according to an embodiment of the present general inventive concept.

FIG. 3 is a perspective view of a projection television according to an embodiment of the present general inventive concept.

### DETAILED DESCRIPTION OF THE PREFERRED EMBODIMENTS

Reference will now be made in detail to the embodiment of the present general inventive concept, illustrated in the accompanying drawings, wherein like reference numerals refer to like elements throughout. The embodiment is described below so as to explain the present general inventive concept by referring to the figures.

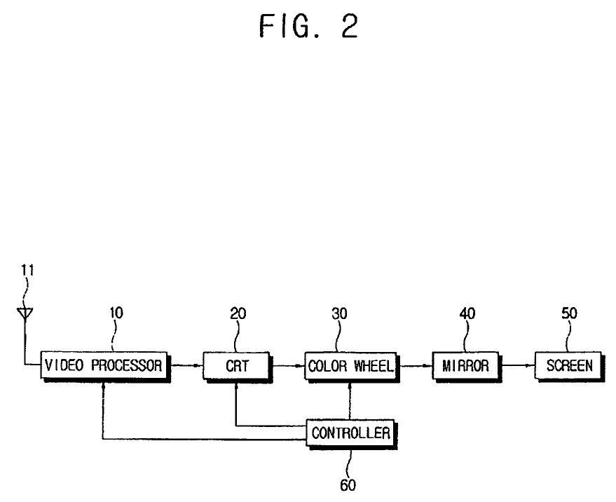

As shown in FIG. 2, a projection television according to an embodiment of the present general inventive concept comprises a video processor 10, an antenna 11, a single CRT 20, a color wheel 30, a mirror 40, a screen 50 and a controller 60.

The video processor 10 processes an input video signal, for example a broadcasting signal received through the antenna 11, and may comprise a tuner (not shown) that selects a channel of the broadcasting signal so as to receive the broadcasting signal according to the selected channel. The video processor 10 may process other input video signals besides the broadcasting signal.

The video processor 10 decodes, amplifies and processes the input video signal such as the broadcasting signal, and outputs the processed signals to the CRT 20. The input video signal is separated into R, B, and G signals during processing by the video processor 10, and the R, B, and G signals are provided to the CRT 20 after being merged or arranged in a sequence.

The CRT 20 transforms the R, G, and B signals from the video processor 10 into optical signals, for example, light corresponding to the R, G, and B signals, and outputs the light. The CRT 20 comprises a cathode, an electron gun, a deflection yoke, a phosphor, a lens, etc.

The electron gun installed in the cathode of the CRT 20 emits cathode electrons according to the R, G, B signals processed by the video processor 10, and the cathode electrons are scanned through a tube toward an anode. Then the deflection yoke deflects the electrons in the up, down, right and left directions when the electron gun transforms the sequence of R, G, B signals into the electrons to be scanned.

The electrons are transformed into light by landing on a fluorescent substance. Brightness of an image on the screen 50 is proportional to the number of electrons because an intensity of a stimulus to the fluorescent substance depends on the number of electrons.

Accordingly, the light intensity is modulated or changed depending on the number of the electrons when the electrons are transformed into light.

The CRT 20 comprises a lens, and the lens comprises a colorless C-lens. The light passing through the C-lens is output as light such as a white light (comprising components having wave lengths between 290 nm˜810 nm).

After passing through the C-lens, the light is divided into red, green and blue colored-light by the color wheel 30 disposed in front of the C-lens at a predetermined distance.

The color wheel 30 comprises red, green and blue color filters. When the optical signals according to R, G and B signals are projected through the CRT 20, the optical signals are transformed into red, green or blue colored-light by the color filter.

The red, green and blue colored-light are projected to the screen 50 after being reflected by the mirror 40. Accordingly a user may see a colored image displayed on the screen 50, corresponding to the input video signal.

The controller 60 controls the video processor 10 and the CRT 20. The controller 60 may be realized by a micro controller or other devices suitable to perform the intended purpose. The controller 60 controls the rotation of the color wheel 30 and based on the R, G and B signals the respective colored-light is projected from the CRT 20.

Also, the controller 60 controls the rotation of the color wheel 30 to rotate with a predetermined frequency, the frequency being determined based on a frequency of the input video signals.

As an example, the color wheel 30 rotates 60 times per second when the frequency is 60 Hz in a national television system committee (NTCS) method, and the CRT 20 projects the light based on the R, G and B signals in sequence whenever the color wheel 30 rotates. In contrast to the conventional projection television, when the number of CRTs is three the CRTs scan the respective beam of the electron in each of the three CRTs. However, the single CRT 20 according to the present general inventive concept scans a beam of the light three times faster than the conventional projection television.

The controller 60 controls a frequency of rotation of the color wheel 30 based on the frequency of the input video signals projected from the CRT 20 and the R, G and B signals corresponding to the input video signal. Also, the controller 60 controls the light to divide into red, green and blue colored-light by passing through the color filter on the color wheel 30.

In other words, the controller 60 controls the color wheel 30 to filter the light into the red, green and blue colored-light based on the order of the R, G and B signals in the sequence.

The controller 60 controls the change of the light into the red, green and blue colored-light by controlling the color wheel 30 to rotate according to a determined period, and to locate the color wheel 30 so that the R, G, and B color filters disposed in front of the CRT 20 correspond to the respective R, G, or B signal in the sequence.

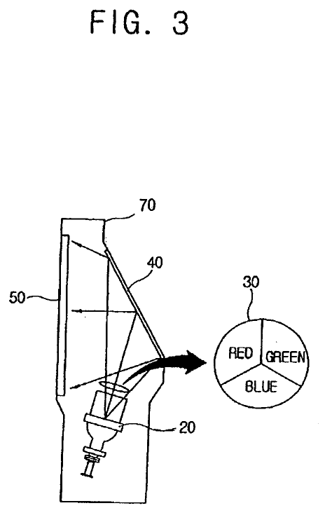

The configuration of the embodiment of the projection television according to the present general inventive concept will be described by referring to FIG. 3.

As shown in FIGS. 2 and 3, the projection television includes a housing 70 to accommodate a CRT, a color wheel, a mirror and a screen and the light projected from the CRT 20 is divided in the red, green and blue colored-light by passing through the color wheel 30. The color wheel 30 comprises the red, green and blue color filters in sequence, and rotates according to the frequency of the input video signal and correlated with the sequence of the R, G and B signals by the controller 60.

The red, green and blue colored-light resulting from the light passing through the color wheel 30 are reflected on the mirror 40 and projected onto the screen 50. Accordingly, a user may see a colored image corresponding to the input video signal.

A location of the colored-light incident on the screen 50 is determined by an angle of reflection, and the angle of the reflection is controlled by the deflection yoke as described above.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A projection television comprising;
a video processor to process input video signals;
a single CRT to project light according to the processed video signals;
a color wheel located in a front of the CRT to filter the light projected from the CRT into predetermined colored-light corresponding to the respective processed video signals; and
a controller to control a rotation of the color wheel according to the input video signals.

2. The projection television according to claim 2, wherein the video processor processes the input video signals to divide into R, G, and B signals, and to merge the R, B, and G signals in a sequence; and
the CRT projects the light according to the merged R, G, and B signals in the sequence.

3. The projection television according to claim 2, wherein the controller controls the color wheel to filter the light into red, green and blue colored-light based on the R, G, and B signals corresponding to the light which is projected from the CRT.

4. The projection television according to claim 1, wherein the colored light comprises red, green and blue colored light, and the color wheel comprises red, green and blue color filters to generate the rede green and blue colored light from the projected light.

5. The projection television according to claim 1, wherein the CRT comprises a colorless lens through which te light projected from the CRT is transmitted.

6. The projection television according to claim 1, wherein the controller controls the color wheel to rotate according to a predetermined frequency corresponding to a frequency of the input video signals.

7. A projection television comprising:
a single CRT to project light according to a video signal;
a color wheel having a plurality of filters to receive the light and to generate colored-light;
a mirror to reflect the colored-light; and
a screen to project the reflected colored-light as an image.

8. The projection television according to claim 7, wherein the video signal comprises R, G, and B signals.

9. The projection television according to claim 7, wherein the video signal comprises a plurality of color signals arranged in sequence, and the color wheel generates the colored-light corresponding to the respective color signals.

10. The projection television according to claim 7, wherein the light comprises a first sub-light, a second sub-light, and a third sub-light, the plurality of filters comprises a first filter, a second filter, and a third filter which correspond to the first, second and third sub-light, respectively.

11. The projection television according to claim 7, wherein the video signal comprises first, second and third color signals, the light comprises first, second, and third sub-light generetaed from the single CRT according to the first, second and third color signals, respectively, the plurality of filters comprises a first filter, a second filter, and a third filter to generate first, second, and third colored light generated by the first, second and third filters according to the first, second and third sub-light, respectively.

12. The projection television according to claim 11, wherein the mirror sequentially reflects the first, second and third colored light toward the screen.

13. The projection television according to claim 7, further comprising:
a controller to control the color wheel to correspond the plurality of filters to respective components of the video signal.

14. The projection television according to claim 7, wherein the video signal comprises a plurality of colors signals, and the color wheel controls the plurality of filters to generate the colored-light corresponding to the respective color signals in response to the projected light.

15. The projection television according to claim 7, wherein the colored wheel is disposed between the CRT and the mirror.

16. The projection television according to claim 7, further comprising:
a housing to accommodate the single CRT, the color wheel, the mirror and the screen therein.

17. The projection television according to claim 16, wherein the housing does not accommodate an additional CRT therein other than the single CRT.

18. The projection television according to claim 7, further comprising:
a video processor to process the video signal to generate R, G, and B signals,
wherein the single CRT projects first second and third sub-light as the light corresponding to the R, G, and B signals.

19. The projection television according to claim 18, wherein the plurality of filters comprise R, G, and B filters to generate R, G, and B colored light corresponding to the first, second and third sub-light, respectively, as the colored light.

20. A projection television comprising:
a housing;
a single CRT disposed in the housing to project a first, a second and a third light according to a first, a second and a third video signals;
a color wheel disposed in the housing to generate the first, the second and the third colored-light according to the projected first, second and third light, respectively;
a mirror to sequentially reflect the first, second, and third colored light; and
a screen to display an image according to the reflected first second and third colored-light.
